(19) United States
(12) Patent Application Publication
(10) Pub. No.: US 2022/0300513 A1
(43) Pub. Date: Sep. 22, 2022

(54) ASYNCHRONOUS QUERY OPTIMIZATION USING SPARE HOSTS

(71) Applicant: International Business Machines Corporation, Armonk, NY (US)

(72) Inventors: Artur M. Gruszecki, Kraków (PL); Tomasz Kazalski, Balice (PL); Tomasz Sekman, Kraków (PL); Andrzej Jan Wrobel, Kraków (PL)

(21) Appl. No.: 17/206,408

(22) Filed: Mar. 19, 2021

(51) Int. Cl. G06F 16/2453; G06F 16/22

(52) U.S. Cl. CPC G06F 16/24545; G06F 16/24544; G06F 16/2255

(57) ABSTRACT

A method and apparatus utilize idle processor time on spare host(s) in an SQL environment to select a query plan. The method comprises receiving a set of query plans for searching a database, and determining that at least one of the set of query plans was generated using heuristic techniques. One or more otherwise idle processors generate a plurality of alternative search plans. The plurality of alternative plans comprise all SQL-conforming search plans to a query with different join orders. Using the one or more otherwise idle processor(s) on one or more spare host(s) within the SQL environment, a resource cost is calculated for executing each alternative search plan within the plurality of alternate search plans. An optimal search plan is identified using the calculated resource costs, and is stored for use in a subsequent search. Such a query can reduce the resources needed to perform a search.

### BACKGROUND

The present disclosure relates to database systems, and more specifically, to asynchronous query optimization using spare hosts.

The development of the EDVAC system in 1948 is often cited as the beginning of the computer era. Since that time, computer systems have evolved into extremely complicated devices. Today's computer systems typically include a combination of sophisticated hardware and software components, application programs, operating systems, processors, buses, memory, input/output devices, and so on. As advances in semiconductor processing and computer architecture push performance higher and higher, even more advanced computer software has evolved to take advantage of the higher performance of those capabilities, resulting in computer systems today that are much more powerful than just a few years ago.

One common application of these capabilities is the database. Databases are computerized information storage and retrieval systems, which can be organized in multiple different ways. An overall database organization is typically referred to as a schema for the database. Schemas, in turn, may be compactly expressed using table names and names of columns in tables.

Database schemas frequently take the form of a “star”, where there is one large “mother” table and many small “detail” tables. For example, a simple database schema including a large mother table “Name/Address” and a small detail table “City” could be expressed as:
Name/Address (LastName, FirstName, M.I., PostalCode, . . . ) City (CityName, PostalCode)
   By way of example, the Name/Address table stores names, addresses, and additional information for individuals in a multiplicity of columns “LastName”, “FirstName”, etc. Each row of the Name/Address table may be associated with a specific individual. The City table may store city names and postal codes in two columns “CityName” and “PostalCode”, respectively. Each row of the City table may link a particular city name to a specific postal code. The PostalCode columns in the City and Name/Address tables are configured to join both tables.

Query processing and the resulting query workload can consume significant system resources, particularly processor and input/output (I/O) resources. In many cases, the system resource consumption of a query against one or more databases may depend on the complexity of the query and the searched database(s). One solution provided herein, according to embodiments, utilizes idle processing time on spare hosts to generate a plurality of alternative search plans. An optimal search plan is identified using the calculated resource costs, and this optimal search plan is stored in a storage within the SQL environment for use in a subsequent search. Such a query can reduce the resources needed to perform a search, particularly within large databases.

### SUMMARY

According to embodiments of the present disclosure, a method is provided for utilizing idle processor time on spare host(s) in an SQL environment to select a query plan. The method comprises receiving, from a database system of an SQL environment, a set of query plans for searching a database, and determining that at least one of the set of query plans was generated using heuristic techniques. One or more otherwise idle processors on one or more spare hosts within the SQL environment generate a plurality of alternative search plans. The plurality of alternative plans comprise all SQL-conforming search plans to a query with different join orders. The method further comprises calculating, using the one or more otherwise idle processor(s) on one or more spare host(s) within the SQL environment, a resource cost for executing each alternative search plan within the plurality of alternate search plans. An optimal search plan is identified using the calculated resource costs, and this optimal search plan is stored in a storage within the SQL environment for use in a subsequent search. Advantageously, such a query can reduce the resources needed to perform a search, particularly within large databases.

According to some embodiments, one or more primary hosts within the SQL environment receives a new query from a requesting entity, and searches the storage to identify a search plan for the new query. Advantageously, this may utilize fewer resources to perform the searching.

According to some embodiments, in response to identifying a search plan in the storage, the method comprises executing the new query according to the search plan in the storage. Advantageously, this retrieves the results of the new query more quickly and efficiently.

According to some embodiments, the method comprises searching the storage to identify the search plan for the new search query comprises generating a hash of the new query; searching a fingerprint registry for the hash; and identifying an index associated with the hash, and using the index to identify the search plan in the storage. Advantageously this approach speeds up the access for data specified in the search query.

According to some embodiments, the method comprises, in response to not identifying a search plan in the storage using heuristics to generate a search plan for the query, and executing the new query according to the heuristically generated search plan. Advantageously, executing the new query in this way results in a significant amount of resource saving.

According to some embodiments, via the one or more otherwise idle processors on the one or more spare hosts within the SQL environment identifying a plurality of query plans that were generated using heuristic techniques, and determining, from the identified plurality of query plans and according to an execution frequency threshold, a set of primary search plans. Advantageously, determining a set of primary search plans helps to reduce resource usage when conducting the search.

According to some embodiments, the method comprises generating, via the one or more otherwise idle processors on the one or more spare hosts within the SQL environment, a plurality of alternative search plans for each of the set of primary search plans, where the plurality of alternative plans comprise all SQL-conforming search plans with different join orders. Advantageously, use of the otherwise idle processors to generate alternative search plans can shorten the amount of time needed for the operation.

According to some embodiments, the one or more otherwise idle processors on the one or more spare hosts within the SQL environment determine, from the identified plurality of query plans and according to the execution frequency threshold, a set of secondary search plans. One or more of the secondary search plans may be deleted from the storage.

In some embodiments, an apparatus is provided to perform aspects of the above-identified method. Similarly, a computer readable medium may comprise instructions that, when executed on a processor, cause the processor to perform aspects of the above-identified method.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates one embodiment of a data processing system, consistent with some embodiments.

FIG. 2 is a block diagram illustrating an example high availability (HA) SQL environment, consistent with some embodiments.

FIGS. 3A-3B (collectively FIG. 3) are parts of a flowchart of an asynchronous query optimization method that may be performed on the primary hosts, consistent with some embodiments.

FIG. 4 is a flowchart of an asynchronous query optimization method that may be performed on one of the spare hosts, consistent with some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to database systems—more particular aspects relate to asynchronous query optimization using spare hosts. While the present disclosure is not necessarily limited to such applications, various aspects of the disclosure may be appreciated through a discussion of various examples using this context.

In some embodiments of this disclosure, a requesting entity (e.g., an application, the operating system, or a user) may request access to a specified database, or collection of databases, by issuing a database access request. Such requests may include simple catalog lookup requests or transactions, and may include combinations of transactions that operate to read, change, and add specified records in the database. These requests may be made using high-level query languages, such as the Structured Query Language (SQL).

The term “query” may refer to a set of commands for retrieving, adding, and/or manipulating data from a stored database, such as a relational database within an SQL environment. Queries may take the form of a command in SQL that lets programmers and programs select, insert, update, find out the location of data in a database, and so forth. For instance, SQL typically supports four types of query operations, i.e., SELECT, INSERT, UPDATE and DELETE. A SELECT operation may retrieve data from a database, an INSERT operation may add new data to a database, an UPDATE operation may modify data in a database, and a DELETE operation may remove data from a database.

Queries may involve data selections based on attributes of detail tables followed by retrieval of information for searched data records, e.g., rows from a corresponding mother table. By way of example, using the City and Name/Address tables described above, a query can be issued to determine all individuals living in a particular city. To this end, all rows in the City table may be scanned to find those rows having the corresponding city name in the CityName column, and then the postal codes in those rows may be retrieved from the PostalCode column. Subsequently, the Name/Address table may be scanned to locate all rows having one of the retrieved postal codes in the PostalCode column. The located rows may contain the searched information related to the individuals residing in the particular city.

Query processing and the resulting query workload can consume significant system resources, particularly processor and input/output (I/O) resources. For example, some queries in real world applications require hours for the resulting data gathering, retrieving, and sorting operations to complete. In many cases, the system resource consumption of a query against one or more databases may depend on the complexity of the query and the searched database(s). For example, assume a large data warehouse runs in a production environment for its intended use in the day-by-day business of a company. The production environment may support query requests submitted to the large data warehouse. The data warehouse may include large sets of data for data mining environments, such as insurance claims, property listings and the medical industry. The large sets of the data may be organized, for instance, in a relational database schema in large distributed databases arranged in a distributed environment. In the distributed environment, a given query may be executed against multiple databases. Accordingly, executing queries against the large data warehouse may lead to searches that consume significant system resources.

Large database applications may utilize “query optimizers” to partially mitigate these issues. A query optimizer generally refers to an application that generates one or more plans (i.e., strategies) on how to perform a search for a given set of search parameters and according to known characteristics of the database(s). Plan generation is typically one of the principal steps during the execution of the SQL commands, which usually takes place just after parsing a query.

The SQL language is declarative, however, so there are alternative methods of processing SQL statements, with widely varying performance. For example, one of the main planner tasks is to set an optimal order of joining the tables. To show how processing order can influence the cost of a query, assume that there are the following tables (row numbers obtained from database statistics from the database catalog):
t1 with 100,000,000 rows,
t2 with 1,000 rows,
t3 with 10 rows
   and the following select:
select * from t1, t2, t3 where t1.a=t2.b and t2.c=t3.d
   For a query as above, a database engine could join: 1) t1 with t2 and then t3 (this is plan 1 in this example); or 2) t2 with t3 and then t1 (this is plan 2 in this example). For plan 1, the database processes the first join: t1 with t2=(100,000,000*1000)/join_rate (usually assumed as 10)=10,000,000,000 operations, and then the second join with t3=(10,000,000,000 (from the first join)*10)/join_rate (usually assumed as 10)=10,000,000,000 additional operations. So, in total for plan 1 in this example, there would be 20,000,000,000 operations. For plan 2 in this example, the first join t2 with t3→(1,000*10)/join_rate (usually assumed as 10)=1,000. The second join with t1=(1,000 (from the first join)*1 000 000 000)/join_rate (usually assumed as 10)=10,000,000,000. So in total, there would be 10,000,001,000 operations for plan 2. To mitigate this disparity, some embodiments may include a special process inside the query optimizer, called a planer, that is responsible for choosing an optimal path of execution for a particular statement.

One possible approach to choosing a query execution plan is to generate all possibilities of a table join order, then calculate the cost of the operations for all of them, and then choose the one with the lowest costs. This approach works fine if the number of tables participating in a query is small. However, the query optimizer and/or planner is itself a workload that requires computing resources, particularly when the number of tables is huge, and the number of the different orders of joins grows significantly. This is particularly true for architectures like snow-flake tables. Additionally, the optimization process itself takes valuable time that could be spent processing the query. Therefore, in practice, query optimizers typically use heuristics to identify a reasonable search strategy in a reasonable amount of time. Generally, there are two different types of heuristics: RBO—Rule-Based Optimizers, and CBO—Cost-Based Optimizers. Regardless of the heuristics used, the resulting plan will generally be sub-optimal, as is generated with some assumptions and subject to time constraints.

Many queries may also be executed repeatedly. For instance, assume a researcher who frequently performs an identical search for data in the data warehouse by repeatedly issuing the same query. The first execution of the query may result in an initial query result. The second and all subsequent executions may, in this example, be an attempt to find new data in the data warehouse that matches the original query. The new data may be added to or removed from the data warehouse by update, delete, or insert operations on the data in the data warehouse. Assume now that the query consumes significant system resources and that no new data is added to or removed from the data warehouse between different executions of the query. In this case, each time the query is re-issued, it will be re-executed against the large data warehouse and re-consume those system resources.

In a production environment, queries may be issued by an issuing entity, such as an application or user, against the database(s). When the production environment receives a query from an issuing entity, a verification may take place to determine whether the received query is re-executable. In the context of the disclosure, a query is “re-executable” if the issuing entity intends to execute the query two or more times against the database(s). A query can also be determined as “re-executable” if the query is executed more than once against the database(s). If the received query is re-executable, it is initially executed against the database(s) to obtain an initial query result. The initial query result is returned to the issuing entity. Subsequently, re-execution of the query is managed to optimize system resource use in the production environment.

Some embodiments may collect execution plans of re-executable queries for feature usage. Performance information associated with each plan may be collected by the database system and may include the specific SQL statement, its priority, its execution time, and the order in which tables are joined during execution. Each plan additionally may also be easily identified by a hash generated from the specific SQL statement (typically made without query parameters).

Some database appliances, particularly those designed for high availability (HA) workloads, may have a plurality of spare resources (e.g., one or more spare hosts) standing in readiness to take the workload in case of failure (e.g., of the main host). These spare resources may share the database catalog and plan cache with the main resource, but typically stand idle most of the time. Some embodiments may utilize these idle resources (e.g., processor time) to perform a far-reaching search for better query plans.

In some embodiments, a far-reaching search for better query plans on the spare host may be accomplished by: (i) adding a remark to each plan that allows for determining if the plan was obtained as a result of a heuristic (reducing the join possibilities), e.g., HEURISTIC=Y; (ii) providing a “plan scanner” responsible for filtering long-running plans marked as HEURISTIC; (iii) aggregating the results of the filtering to obtain the top frequently executed query; (iv) adding such a query to a dedicated plan registry (R1); and (v) removing “old” plans from the registry R1 in the case where the plan was not utilized for a long time (as defined as a parameter).

Some embodiments may, for each plan in the R1 registry or for a subset of high priority plans (determined e.g., according to an execution frequency threshold), generate all possible alternative plans (conforming to the SQL correctness) for the query with different join orders, and then store the alternative plans in the shared storage S1. These embodiments may then iterate one-by-one through the alternate plans and calculate its cost to determine an optimal (e.g., lowest cost) plan. These embodiments may then replace the original (e.g., heuristically generated) plan with the optimal plan identified by the far-reaching search in the shared storage S1.

When this iteration is complete, some embodiments may then mark the plan in the R1 registry as optimized (e.g., to not process it again). The results of these operations may include: (i) a registry R1 shared between hosts containing a hashed SQL, which may be used to easily match new queries with the optimized plans; and (ii) a plurality of optimized query plans shared between hosts in the shared storage S1 storage.

One feature and advantage of some embodiments is that the operations described above (e.g., filtering, aggregation to registry R1, plan generation to the shared storage S1, and cost calculation) may be done using the otherwise idle processor(s) of the spare host. The primary host(s) may, in response to receiving a new query (which may involve a huge number of the tables), first determine if there is an entry for that query in the registry R1 using, for example, a hash of the SQL statement. If a plan exists, then the primary host(s) use an index stored in the R1 registry to identify a corresponding plan in the shared storage S1. The primary host may use that plan to process the received query.

### Data Processing System

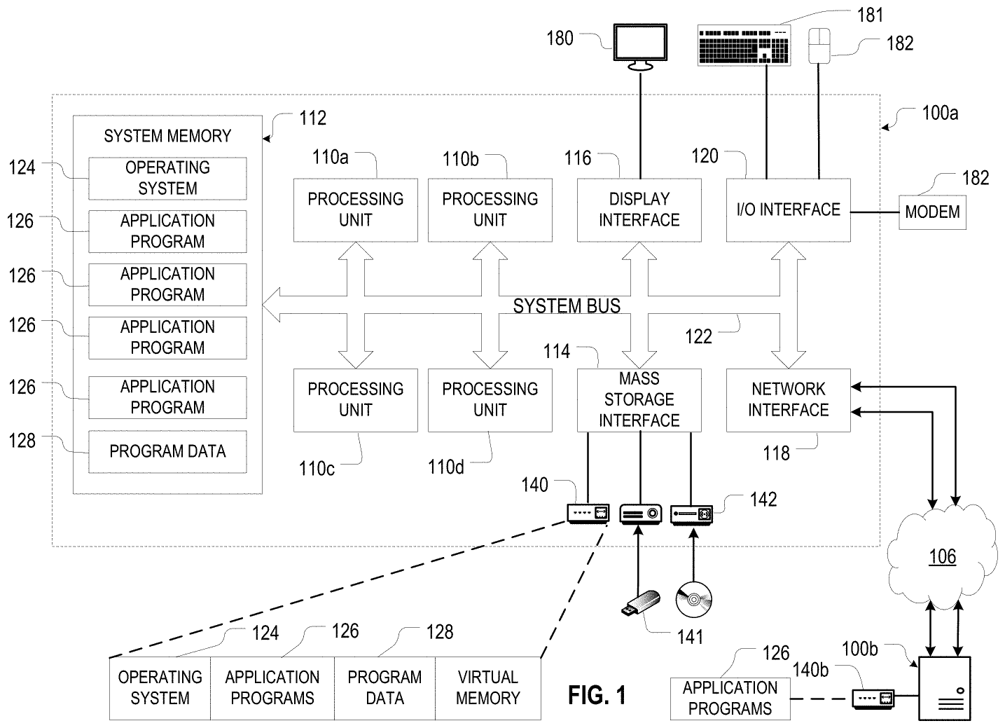

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, PDA (Personal Digital Assistant), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and that the number, type, and configuration of such components may vary.

The data processing system 100 in FIG. 1 may comprise a plurality of processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interfaces 114 in this embodiment may connect the system bus 122 to one or more mass storage devices, such as a direct access storage device 140a, 140b, a USB drive 141, or a readable/writable optical disk drive 142. The network interfaces 118 may allow the DPS 100a to communicate with other DPS 100b over a network 106. The main memory 112 may contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the computing systems 100 may only comprise a single processor system and/or a single processor designed to emulate a multiprocessor system. Further, the processor(s) 110 may be implemented using a number of heterogeneous data processing systems 100 in which a main processor 110 is present with secondary processors on a single chip. As another illustrative example, the processor(s) 110 may be a symmetric multiprocessor system containing multiple processors 110 of the same type

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices, which are in communication with the processor(s) 110 through the system bus 122. The program code in the different embodiments may be embodied on different physical or tangible computer-readable media, such as the memory 112 or the mass storage devices. In the illustrative example in FIG. 1, the instructions may be stored in a functional form of persistent storage on the direct access storage devices 140a, 140b. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage devices 140a, 140b may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts that the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like.

The terminal/display interface 116 may be used to directly connect one or more displays 180 to the data processing system 100. These displays 180 may be non-intelligent (i.e., dumb) terminals, such as an LED monitor, or may themselves be fully programmable workstations that allow IT administrators and users to communicate with the DPS 100. Note, however, that while the display interface 116 may be provided to support communication with one or more displays 180, the computer systems 100 does not necessarily require a display 180 because all needed interaction with users and other processes may occur via the network 106. The I/O interface may connect one or more I/O devices, such as a keyboard 181, mouse 182, modem 183, and/or printer (not shown).

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “InfiniBand” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

### High Availability Systems

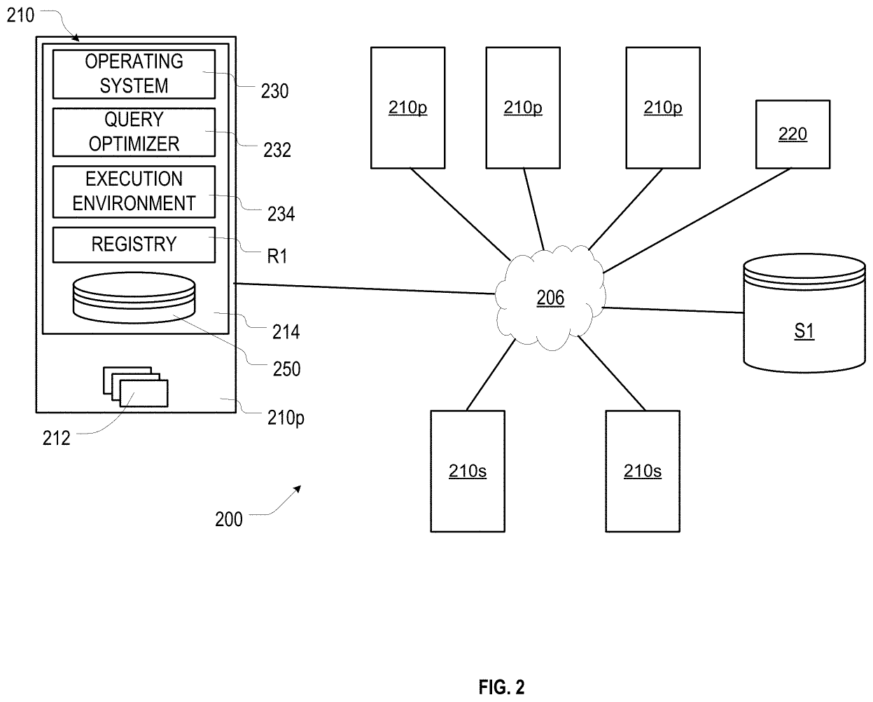

FIG. 2 is a block diagram illustrating an example high availability (HA) SQL environment 200, consistent with some embodiments. As illustrated in FIG. 2, the SQL environment 200 may comprise a plurality hosts 210 connected by a communication network 206 (only one shown in detail for clarity). Each host 210 may comprise one or more processors 212 and a memory 214. The memory 214, in turn, may contain an operating system 230, a query optimizer 232 for generating an analyzing query execution plans, a query execution component 234, a copy of a database 250, and a global (i.e., shared between hosts) dedicated plan registry R1 (only one host 210 depicted in detail for clarity). Some of the hosts 210 may be currently designated as primary hosts 210p, and some of the hosts 210 may be currently designated as spare hosts 210s to be held as backup in case of a failure of one or more of the primary hosts 210p. All of the hosts 210 may have access to a shared storage S1, which may contain query execution records for a plurality of previously received queries, associated query plans, and a last execution date. In some embodiments, each query execution record in S1 may correspond to a single query and its related information. The plan registries R1 may also contain fingerprints of the plurality of previously received queries and indexes to the associated query execution record in S1.

In response to receiving a query from an application 220 (or any requesting entity), one of the primary hosts 210p will be selected handle primary computing functions. The selected primary host may first fingerprint the query, and then may determine if the registry R1 contains a matching fingerprint, indicating whether the query has been previously received and has a plan stored in the shared storage S1. If the query has not been previously received, then the query optimizer 232 may be configured to generate an execution plan for the query execution component(s) 234, optimized consistent with a set of heuristic rules and time constraints. The query may then be executed using the execution plan and the result returned to the application 220.

As will be discussed in more detail below, the fingerprint for the query may be stored in the registry R1, together with an index to the associated query execution record in S1. A query optimizer 232 executing on, for example, one or more of the spare hosts 210s may periodically access the shared storage S1 to perform a far-reaching search for optimal (e.g., faster, requiring fewer resources, etc.) execution plan(s) to perform the query statement(s) stored therein. When an optimal plan is found for one of the queries, the spare host 210N may store that optimal plan in the shared storage S1, replacing the previous (e.g., heuristically generated) plan. As a result, if all of the hosts 210 are executing normally, queries may be generated and executed in the primary hosts 210p, and tested and/or evaluated asynchronously on one of the spare hosts 210s.

Once query plans have been stored in the shared storage S1, it may no longer be necessary for the primary hosts 210p to generate a new plan when that same query is later received, which may enhance the SQL environment 200 performance by speeding query execution. Instead, the primary host 210p may fingerprint the received query, determine if a matching record exists in the query registry R1, index into the shared storage S1, and retrieve an optimized plan for the query (e.g., the improved access plan identified using testing performed on the spare hosts 210s). The primary host 210p may then execute the query using the retrieved optimized plan.

If one of the primary hosts 210p fails, then one of the spare hosts 210s may be re-designated as a primary host 210p, consistent with HA techniques. If no spare hosts 210s remain in the system 200, the system may continue to receive and execute queries using the primary hosts 210. Asynchronous query improvement, however, may be paused until a new spare host 210s can be added to the system 200.

### Example Operations for Asynchronous Optimization

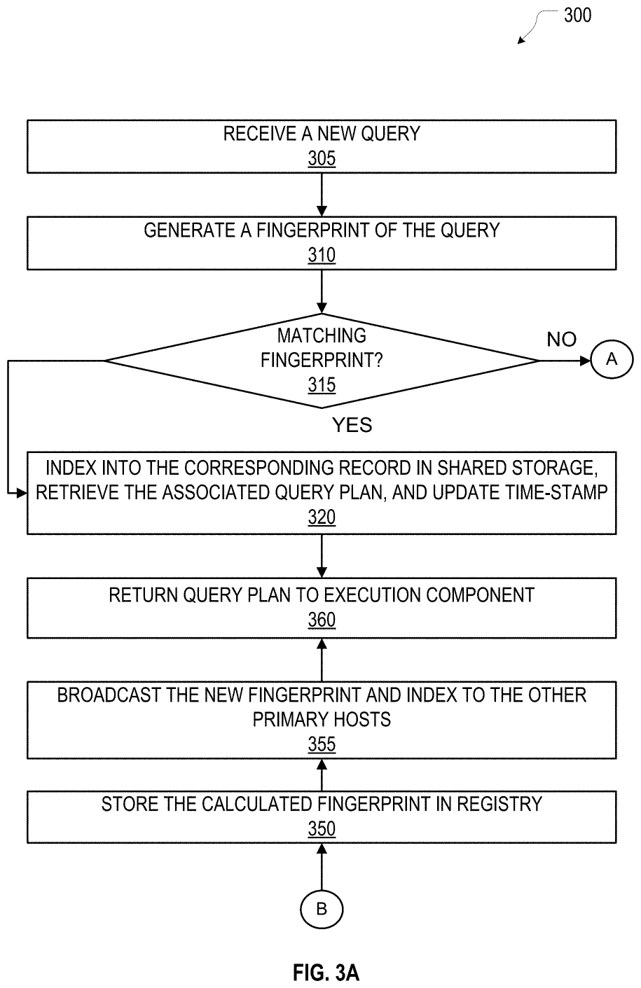

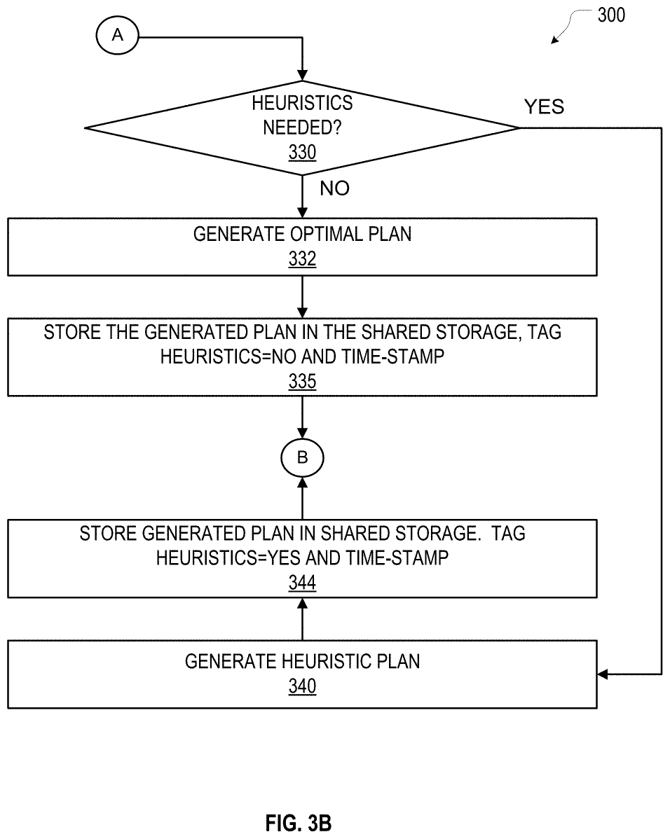

FIGS. 3A-3B (collectively FIG. 3) are parts of a flowchart of an asynchronous query optimization method 300 that may be performed, for example, on the primary hosts 210p. The flowchart begins at operation 305 by receiving a new query from an application 220 or other requesting entity. In some embodiments, this query may initially be sent to a load balancing appliance (not shown) and then re-distributed to one of the primary hosts 210p. In response, the primary host 210p that receives the new query may first generate a fingerprint of the query at operation 310. This operation may comprise using a hash function to map the new query to a fixed-size value that may be used as a digital signature to uniquely identify the query.

Next, at operation 315, the primary host 210p may determine whether or not a matching fingerprint exists in its copy of the registry R1. If a matching fingerprint exists (315=yes), the query optimizer 232 may index into the corresponding record in the shared storage S1, retrieve the associated query plan, and update the plan's last execution time-stamp to the current time at operation 320. The query optimizer 232 may then return the retrieved plan to the query execution component 234 for execution at operation 360.

If a matching fingerprint does not exist (315=no), the query optimizer 232 may begin to process the query. Processing may begin at operation 330 by determining whether heuristics will be necessary to calculate a plan. If heuristics are not necessary (e.g., because an optimal strategy can be calculated within a predetermined threshold of time), then the query optimizer 232 may generate the optimal plan at operation 332. Next, the query generator 232 may store the generated optimal plan in the shared storage S1, together with a tag indicating that heuristics were not necessary (e.g., HEURISTICS=NO) and the current time-stamp, at operation 335. The query optimizer 232 may then store the calculated fingerprint in its registry R1 at operation 350, together with an index to the corresponding plan in shared storage S1, at operation 350. The query optimizer 232 may then broadcast the new fingerprint and index to the other primary hosts 210p at operation 355, and then return the calculated optimal strategy to the query execution component 234 at operation 360.

If, however, heuristics are determined to be necessary (operation 315=no and operation 330=yes), then the query optimizer 232 may apply a rule-based optimizer strategy or a cost-based optimizer strategy to calculate reasonable (but likely sub-optimal) execution plan at operation 340. The query optimizer 232 may store that reasonable plan in shared storage S1, together with a tag indicating that heuristics were used (e.g., HEURISTICS=YES) and the current time-stamp, at operation 342. Next, the query optimizer 232 may store the calculated fingerprint in its registry R1 at operation 350, together with an index to the corresponding plan in the shared storage S1 at operation 344. The query optimizer 232 may then broadcast the new fingerprint and the index to the other primary hosts 210p at operation 355 to store in their registries R1, and then return the reasonable plan to the query execution component 234 at operation 360.

At operation 365, the query execution component 234 may execute the plan received from the query optimizer component 232. Flow 300 may end with the primary host 210p returning the corresponding results to the requesting application at operation 370.

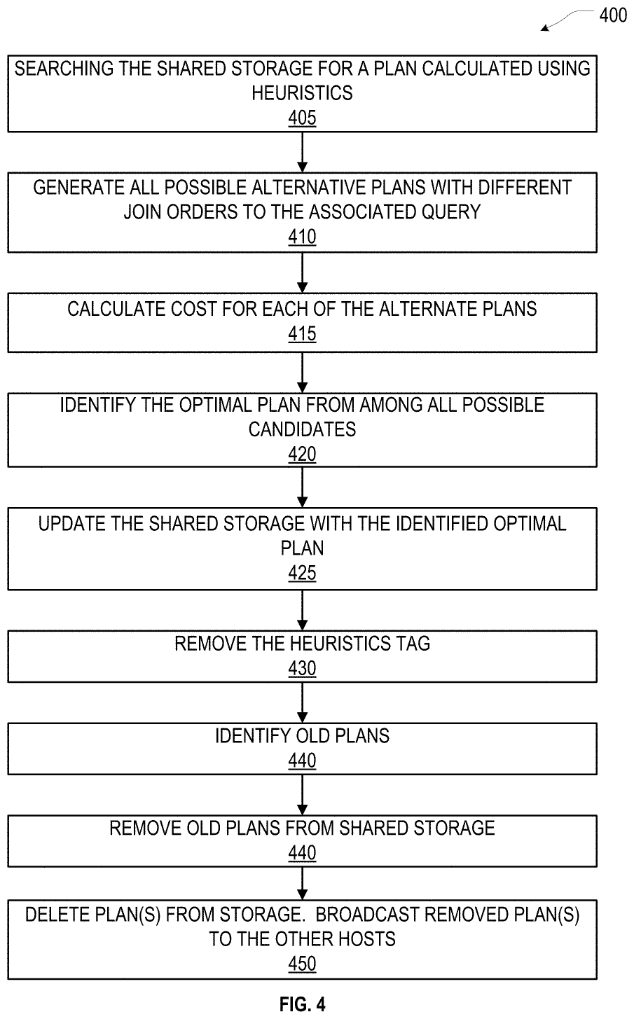

FIG. 4 is a flowchart of an asynchronous query optimization method 400 that may be performed, for example, on one of the spare hosts 210s. Flow 400 may be performed as a loop to allow far-reaching searches for optimal query plans to be performed asynchronously using the resources (e.g., processor(s)) of spare host 210s. For purposes of explanation, the loop begins at operation 405, with the spare host 210s searching the shared storage S1 for a plan marked as having been calculated using heuristics (e.g., HEURISTIC=YES). As previously discussed, that plan may have been stored in the shared storage S1 with its associated query by one of the primary hosts 210p.

If a plan calculated using heuristics is identified, the query optimizer 232 on the spare host 210s may then generate all possible alternative plans (e.g., conforming the SQL correctness) with different join orders to the associated query at operation 410. The query optimizer 232 on the spare host may then iterate, one-by-one, through each of the alternate plans and calculate its cost at operation 415. At operation 420, the query optimizer 232 on the spare host 210s may identify the optimal plan (e.g., lowest calculated cost) from among all possible candidates at operation 420. The query optimizer 232 on the spare host 210s may then update the shared storage S1 with the identified optimal plan, if necessary at operation 425. The query optimizer 232 on the spare host 210s may remove the heuristics tag (HEURISTICS=NO) associated with that query in the shared storage S1 at operation 430.

Additionally or alternatively, some embodiments may generate a list of all of the queries in shared storage S1 that are identified as generated using heuristics. Some embodiments may then generate a set of primary search plans from among that list e.g., those queries having the most recent time-stamps or those having a time-stamp more recent than a threshold time. These embodiments may then generate an optimal search plan for each query in the set of primary search plans using operations 410-430.

Method 400 may continue with the spare host searching the shared storage S1 for any plans having a time-stamp older than a predetermined threshold at operation 440. If such a plan is found, then the processor on the spare host 210s may issue instructions to delete that plan from storage 210 and then may broadcast the removal of the plan from S1 to the primary hosts 210p at operation 450 (e.g., so that the other hosts 210 may update their local fingerprint registries R1. Flow may then return to operation 405.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### General

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Therefore, it is desired that the embodiments described herein be considered in all respects as illustrative, not restrictive, and that reference be made to the appended claims for determining the scope of the invention.

What is claimed is:

1. A method for utilizing idle processor time on spare host(s) in an SQL environment to select a query plan, comprising:
receiving, from a database system of an SQL environment, a set of query plans for searching a database;
determining that at least one of the set of query plans was generated using heuristic techniques;
via one or more otherwise idle processors on one or more spare hosts within the SQL environment:
generating a plurality of alternative search plans, wherein the plurality of alternative plans comprise all SQL-conforming search plans to a query with different join orders;
calculating, using the one or more otherwise idle processor(s) on one or more spare host(s) within the SQL environment, a resource cost for executing each alternative search plan within the plurality of alternate search plans;
identifying an optimal search plan using the calculated resource costs; and
storing the optimal search plan in a storage within the SQL environment for use in a subsequent search.

2. The method of claim 1, further comprising, via one or more primary hosts within the SQL environment:
receiving a new query from a requesting entity; and
searching the storage to identify a search plan for the new query.

3. The method of claim 2, further comprising, in response to identifying a search plan in the storage, executing the new query according to the search plan in the storage.

4. The method of claim 3, wherein searching the storage to identify the search plan for the new search query comprises:
generating a hash of the new query;
searching a fingerprint registry for the hash;
identifying an index associated with the hash; and
using the index to identify the search plan in the storage.

5. The method of claim 2, further comprising, in response to not identifying a search plan in the storage:
using heuristics to generate a search plan for the query; and
executing the new query according to the heuristically generated search plan.

6. The method of claim 1, further comprising, via the one or more otherwise idle processors on the one or more spare hosts within the SQL environment:
identifying a plurality of query plans that were generated using heuristic techniques; and
determining, from the identified plurality of query plans and according to an execution frequency threshold, a set of primary search plans.

7. The method of claim 6, further comprising generating, via the one or more otherwise idle processors on the one or more spare hosts within the SQL environment, a plurality of alternative search plans for each of the set of primary search plans, wherein the plurality of alternative plans comprise all SQL-conforming search plans with different join orders.

8. The method of claim 7, further comprising, via the one or more otherwise idle processors on the one or more spare hosts within the SQL environment:
determining, from the identified plurality of query plans and according to the execution frequency threshold, a set of secondary search plans; and
deleting one or more of the secondary search plans from the storage.

9. An apparatus for utilizing idle processor time on spare host(s) in an SQL environment to select a query plan, comprising:
a memory; and
a processor configured to:
receive, from a database system of an SQL environment, a set of query plans for searching a database;
determine that at least one of the set of query plans was generated using heuristic techniques;
via one or more otherwise idle processors on one or more spare hosts within the SQL environment:
generate a plurality of alternative search plans, wherein the plurality of alternative plans comprise all SQL-conforming search plans to a query with different join orders;
calculate, using the one or more otherwise idle processor(s) on one or more spare host(s) within the SQL environment, a resource cost for executing each alternative search plan within the plurality of alternate search plans;
identify an optimal search plan using the calculated resource costs; and
store the optimal search plan in a storage within the SQL environment for use in a subsequent search.

10. The apparatus of claim 9, wherein the processor is configured to, via one or more primary hosts within the SQL environment:
receive a new query from a requesting entity; and
search the storage to identify a search plan for the new query.

11. The apparatus of claim 10, wherein the processor is configured to, in response to the identification of a search plan in the storage, execute the new query according to the search plan in the storage.

12. The apparatus of claim 11, wherein the search of the storage to identify the search plan for the new search query comprises having the processor:
generate a hash of the new query;
search a fingerprint registry for the hash;
identify an index associated with the hash; and
use the index to identify the search plan in the storage.

13. The apparatus of claim 10, further comprising, in response to not identifying a search plan in the storage, the processor being configured to:
use heuristics to generate a search plan for the query; and
execute the new query according to the heuristically generated search plan.

14. The apparatus of claim 9, wherein via the one or more otherwise idle processors on the one or more spare hosts within the SQL environment, the processor is configured to:
identify a plurality of query plans that were generated using heuristic techniques; and
determine, from the identified plurality of query plans and according to an execution frequency threshold, a set of primary search plans.

15. A computer program product for an adversarial query defense apparatus, the computer program product comprising:
one or more computer readable storage media, and program instructions collectively stored on the one or more computer readable storage media, the program instructions comprising program instructions to:
receive, from a database system of an SQL environment, a set of query plans for searching a database;
determine that at least one of the set of query plans was generated using heuristic techniques;
via one or more otherwise idle processors on one or more spare hosts within the SQL environment:
generate a plurality of alternative search plans, wherein the plurality of alternative plans comprise all SQL-conforming search plans to a query with different join orders;
calculate, using the one or more otherwise idle processor(s) on one or more spare host(s) within the SQL environment, a resource cost for executing each alternative search plan within the plurality of alternate search plans;
identify an optimal search plan using the calculated resource costs; and
store the optimal search plan in a storage within the SQL environment for use in a subsequent search.

16. The computer program product of claim 15, wherein the instructions cause the processor to, via one or more primary hosts within the SQL environment:
receive a new query from a requesting entity; and
search the storage to identify a search plan for the new query.

17. The computer program product of claim 16, wherein the instructions cause the processor to, in response to the identification of a search plan in the storage, execute the new query according to the search plan in the storage.

18. The computer program product of claim 17, wherein the search of the storage to identify the search plan for the new search query comprises having the instructions cause processor to:
generate a hash of the new query;
search a fingerprint registry for the hash;
identify an index associated with the hash; and
use the index to identify the search plan in the storage.

19. The computer program product of claim 16, wherein the instructions further cause the processor to, in response to not identifying a search plan in the storage:
use heuristics to generate a search plan for the query; and
execute the new query according to the heuristically generated search plan.

20. The computer program product of claim 15, wherein the instructions cause the processor to, via the one or more otherwise idle processors on the one or more spare hosts within the SQL environment:
identify a plurality of query plans that were generated using heuristic techniques; and
determine, from the identified plurality of query plans and according to an execution frequency threshold, a set of primary search plans.
